(19) United States
(12) Patent Application Publication
(10) Pub. No.: US 2018/0368394 A1
(43) Pub. Date: Dec. 27, 2018

(54) SEMEN/GAMETE AND EMBRYO STORAGE RECEPTACLES WITH RFID DATA IDENTIFICATION

(71) Applicant: Inteli-Straw, LLC, Weatherford, TX (US)

(72) Inventors: Michael E. Kjelland, Valley City, ND (US); Todd Stroud, Weatherford, TX (US)

(21) Appl. No.: 15/912,783

(22) Filed: Mar. 6, 2018

Related U.S. Application Data
(60) Provisional application No. 62/525,387, filed on Jun. 27, 2017.

(51) Int. Cl. A01N 1/02; G06K 19/04

(52) U.S. Cl. CPC A01N 1/0268; G06K 19/07701; A01N 1/0257; G06K 19/041

(57) ABSTRACT

A container system for cryogenically and non-cryogenically storing and identifying biological material stored therein wherein the container system includes semen straws, vitrification straws, and canes for holding such straws, the present improvement including positioning and locating a radio frequency identification (RFID) tag on or within semen straws, vitrification straws, covers associated with such straws, canes, cane tabs and cane tab covers for holding such straws, and on or within various seals associated with such straws.

### CROSS-REFERENCE TO RELATED APPLICATIONS

This application claims the benefit of U.S. Provisional Application No. 62/525,387 filed Jun. 27, 2017, which application is hereby incorporated herein by reference in its entirety.

### FIELD OF INVENTION

The present invention generally relates to a container system for storage and identification of biological material. More particularly, the present invention relates to a container system that stores biological material, both cryogenically and non-cryogenically, and allows for both the identification of the stored material through RFID chips. The present system also accommodates the traditional artificial insemination (AI) and embryo injection (EI) applications and (AI) guns and are easily insertable into such devices.

### BACKGROUND

Artificial insemination and embryo transfer procedures in animals and humans are well established and is a commercially successful industry. Hundreds of billions of dollars are spent every year on cryopreservation of biological materials, allowing for use of the materials at an appropriate time. The reproductive industry produces millions of units of biological material each year including semen, embryos, gametes, oocytes and other biological tissue, which are stored at very low temperatures in containers or receptacles. These vast amounts of stored biological material must be identifiable. The current method for labeling cryopreserved samples in containers is to use printed labels, hand written labels, color codes, bar codes, or etchings on the outside of the containers themselves.

There is a major deficiency in the use of the present labeling methods including the bar code system in that users may not be able to read these identifying marks. Due to the low temperatures that these biological materials are stored in, frost may accumulate over the markings. Fluid or vapors may also cause the identifying marks to become unreadable. Often times, biological materials must be removed from the cryogenic liquid for the labels to be identified and read, in which removal exposes the material to dangerously warm temperatures which can degrade, damage and/or destroy the biological material when the material is again submerged back into liquid nitrogen. In addition to the difficulty in reading these identifying marks which is extremely time consuming, cross-checking this information for accuracy and reliability is also time consuming and sometimes is not even attempted or completed. It also may be difficult to even locate a particular container, particularly in large groupings of containers and mistakes in identification often occur.

One method of identifying biological materials when cryogenically stored is through the use of radiofrequency identification (RFID) tags attached to the cryogenic container. All appropriate data identifying the biological material in the container such as an assigned code or serial number, name of the sire and/or dam (e.g., semen, oocyte, embryo pedigree), farm/ranch name, owner's name, data collected, concentration, type of semen (e.g., sorted or unsorted), processing unit, grade and other data, can be stored on the RFID tag. However, once the RFID tag is attached to the outside of the container, it is subject to falling off during the freezing process. In some cases, cryogenic containers with the RFID tag attached thereto can be covered with a protective sleeve. See, for example, International Publication No. WO2014/001819 A1. However, sleeves may contract at a different rate than the container it is protecting when freezing, which can lead to the RFID tag being lost, or the sleeve or cryogenic container being damaged. RFID tags attached to the inside of a cryogenic container can cause problems due to the fact that they may be implanted into livestock during fertilization due to their small size. RFID tags in a separate compartment of a container, covered by caps, may also be lost because of the pressure changes encountered during freezing or thawing.

At present, there is not a self-contained, operable system in use that allows for easy labeling of the containers or receptacles housing cryopreserved, or non-cryopreserved, biological material, nor is there an operable system that allows for a person searching for a particular cryopreserved container to find it and get the associated information without having to remove the container from liquid nitrogen or liquid nitrogen vapors as is currently the case with traditionally labeled containers, i.e., straws with laser etched or ink printed labels, which containers have to be visually observed and may require removal from the liquid nitrogen or liquid nitrogen vapors. Existing methods also do not allow for identification without the risk of partially thawing the sample.

It is therefore desirable to create a container system for cryogenically and non-cryogenically stored biological material that allows for identification of the stored biological material through RFID chips, using a method that prevents the loss of the RFID chips or the information stored on the RFID chips.

### SUMMARY OF INVENTION

The present invention described herein is a container system that incorporates an RFID chip therewithin, the container system being used for both cryogenically and non-cryogenically storing biological material. One embodiment for storing biological material is by placing an RFID chip within a semen/embryo straw, a common storage container for semen, oocytes, and embryos. Typically, at least one end the semen straw is closed using a sealing powder sandwiched between a pair of cotton plugs or other suitable material, a separate sealing plug, or other means. The present system includes locating the RFID chip either partially or fully inside the sealing powder component or other sealing means of the straw so that it becomes part of the seal once the straw is filled. Instead of being integrated into the sealing power, the RFID chip may alternatively be placed in a separate sealing plug component of the straw so that it becomes part of the seal when the straw has been filled with biological material. Another embodiment of the present container system includes an RFID chip positioned actually inside the straw. The aforementioned embodiments and methods of incorporating an RFID chip into a semen/embryo straw did not previously exist in the proposed form disclosed herein.

Once a straw has been filled with biological material and sealed, the straw may be stored by placing it within a cane. A cane is essentially a basket with a handle that can hold a plurality of straws, typically one to twenty straws. The cane is labeled with a cane tab, which is preferably a flat removable piece of metal. The cane, with the straw stored therewithin, can then be placed within the cryogenic liquid such as within a Dewar Tank, namely, a canister filled with liquid nitrogen, for storing the biological material. An RFID chip may also be adhered to or integrated within the cane tab or the cane itself. See, for example, http://www.arssales.com/epf-canes.html; htttps://www.bonanza.com/listings/Cryocane-storage-cylinder-holder-canister-for-liquid-nitro genderwar/500629095?goog_pla=1&gpid=18283950120&keyword=&goog_pla=1&pos=1o2 &ad_type=pla&gelid=EAIaIQobChMIk5n9gIL72AIVgrbACh2N-wsNEAYYAiABEgLaNf D_BwE.

In accordance with the teachings of the present invention, an RFID chip may also be used to identify vitrification straws used to store eggs or embryos during vitrification. Vitrification is a method of rapidly cryogenically preserving eggs or embryos so that ice crystals are not formed. Similar to semen straws, an RFID chip may be placed into the vitrification straw itself, its handle, or its seal. The RFID chip may further be located in the cover of a vitrification straw. RFID chips may also be inserted either before or after the vitrification straw has been filled with biological material. Multiple RFID chips may also be used to identify the same biological sample.

### BRIEF DESCRIPTION OF THE DRAWINGS

For a better understanding of the various embodiments of the present invention, reference may be made to the accompanying drawings in which:

FIG. 1 is a front elevation view of a typical semen/oocyte/embryo straw modified to include an RFID chip;

FIG. 2 is a front elevation view of a filled semen/oocyte/embryo straw with an RFID chip fully integrated into the seal;

FIG. 2A is a cross sectional view of a filled semen/oocyte/embryo straw with an RFID chip fully integrated into the seal taken across line 2A-2A in FIG. 2;

FIG. 3 is a front elevation view of a filled semen/oocyte/embryo straw with an RFID chip partially integrated into the seal;

FIG. 3A is a cross sectional view of a filled semen/oocyte/embryo straw with an RFID chip partially integrated into the seal taken across line 3A-3A in FIG. 3;

FIG. 4 is a front elevation view of a vitrification straw with an RFID chip in its cover;

FIG. 4A is an exploded front elevation view of a vitrification straw with an RFID chip in the cover of FIG. 4;

FIG. 5 is a front elevation view of a vitrification straw with an RFID chip in its handle;

FIG. 5A is a cross sectional view of a vitrification straw with an RFID chip in its handle taken across line 5A-5A in FIG. 5;

FIG. 6 is a front elevation view of a vitrification straw in its open position with an RFID chip in the straw;

FIG. 6A is a front elevation view of a vitrification straw in its closed position with an RFID chip in the straw of FIG. 6;

FIG. 7 is a perspective view of a cane and a RFID chip attached to a cane tab cover;

FIG. 8 is a top plan view of an RFID chip adhered to a cane tab on a cane that has been inserted into a Dewar Tank;

FIG. 9 is a front elevation view of a semen straw with an RFID chip on a plug connector end portion; and

FIG. 9A is an exploded front elevation view of a semen straw with an RFID chip on the plug straw connector end portion of FIG. 9.

FIG. 10 is a front elevation view of a filled semen/oocyte/embryo straw with an RFID chip integrated into a hydrogel or other gelatin powder.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION OF THE DRAWINGS

The present invention will now be described with reference to the drawing figures, in which like reference numerals refer to like parts throughout. For purposes of clarity in illustrating the characteristics of the present invention, proportional relationships of the elements have not necessarily been maintained in the drawing figures. In addition, although the various embodiments of the present invention will be hereinafter discussed in relationship to cryogenically stored biological material, it is recognized and understood that the present embodiments and methods for attaching RFID chips to a container system are equally applicable to non-cryogenically stored biological material such as storing semen and embryos in an extender system for transport and use within a pre-determined time period.

There are a variety of straw designs/morphologies which may be used to hold semen and embryos, particularly in the reproductive biology industry. Semen and embryo straws are typically used to store frozen biological samples and allow for a uniform control of the freezing and thawing process, thereby resulting in cell survival. Semen and embryo straws are typically 0.25 to 0.5 mL and made out of plastic and are used for slow cooling methods of cryopreservation. Vitrification straws are used to store eggs, primordial germ cells, semen/sperm, or embryos. Vitrification is an ultra-rapid cooling process that forms a glass-like solid, and prevents ice crystals from forming. Cryoprotectants are used to dehydrate the eggs, semen/sperm, or embryos to reduce or eliminate the formation of ice crystals. The eggs, semen/sperm or embryos are then added to the straws, and then cooled at the appropriate rate.

Semen and embryo straws are cryopreserved and stored in liquid nitrogen. In order to store and more easily retrieve the frozen straws, the straws are usually placed into canes. A cane is an open container, a holder or basket with a handle that typically holds one to twenty straws. Canes often have removable cane tabs located at one end of the cane. Cane tabs are typically a small flat piece of aluminum or other material that may be used as a label. They can be directly written on and can have a labeled cover placed on top of the cane tab to preserve the writing or serve as a label. Canes are then placed into canisters, which are located in Dewar Tanks, which contain liquid nitrogen. Dewar Tanks are a specialized type of a vacuum flask used for storying cryogens, such as liquid nitrogen.

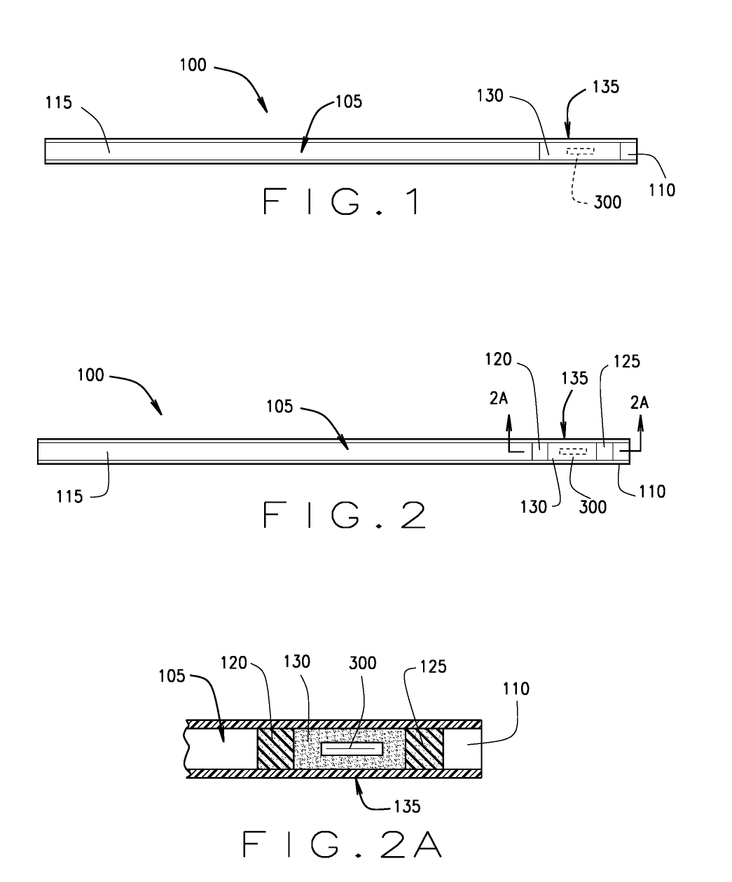

Millions of biological samples are gathered and stored in Dewar Tanks each year, which makes the identification of these biological samples challenging. One embodiment of the present invention that may be used to easily identify a biological sample is shown in FIG. 1, which illustrates a typical semen or embryo straw 100 modified to include an RFID chip as will be hereinafter explained. As seen in FIG. 2, the semen straw 100 includes an elongated annular member 105 having a first end 110 and a second end 115. The first end 110 of straw member 105 has a first plug 120, a second plug 125 substantially similar to first plug 120, and a resin powder 130 sandwiched therebetween. The plugs are preferably made out of cotton but 0.22 micron or 0.5 micron filter paper may also be used to prevent the semen from reaching the resin while allowing only the liquid associated with the semen to pass through to the resin powder for sealing. Additional methods and materials other than plugs and filter paper are also envisioned and foreseeable as suitable substitutes for the cotton plugs 120 and 125. The resin powder 130 or similar sealing substance may be different colors, such as red or white. One embodiment of the present invention includes positioning an RFID chip 300 between the first plug 120 and the second plug 125 fully within the resin powder 130 as illustrated in FIGS. 2 and 2A such that the RFID tag 300 is fully encapsulated within the resin powder.

Air is preferably able to move in between plugs 120 and 125. However, when semen straw 100 is filled with biological material such as semen, the liquid, or extender associated with the sperm in the semen is allowed to penetrate the cotton plugs 120 or 125 or other suitable material such as micron filter paper thereby causing a chemical reaction in the resin powder 130 which allows the resin powder 130 to solidify or harden, thereby creating a seal 135 as shown in FIGS. 2 and 2A. Plugs 120, 125, and the RFID chip 300 remain inside the straw thus when the resin powder 130 hardens due to the chemical reaction, the RFID chip is fully integrated into the seal 135 (FIGS. 2 and 2A). After the semen straw 100 is filled, the second end 115 of straw member 105 is then sealed using a suitable method for sealing the second end 115 of the straw such as heat sealing, crimping, friction plugs, glass/metal bee bees, ultrasonic sealing, a resin powder, or other method.

As shown in FIGS. 3 and 3A, the RFID chip 300 does not have to be fully integrated into the seal, but can be partially integrated instead in certain situations. Straw member 105 has first and second ends 305 and 310. In this embodiment, the second end 310 can include just resin powder 130 and this end 310 can be closed to retain the resin powder therein. This closure can be any suitable know means for closure. The RFID chip 300 can then be tamped at least partially into the resin 130 that seals the second end 310 of straw member 105. Once the semen straw 100 is filled with a biological material, the liquid or extender associated with the semen will then penetrate the resin powder causing the sealing reaction as previously explained. The semen straw 100 can then be processed and placed in liquid nitrogen.

Still further, instead of using a resin powder such as resin powder 130 illustrated in FIG. 1-3A, other sealing substances for sealing, retaining or encapsulating the RFID chip 300 within a semen straw can likewise be utilized. For example, hydrogels, gelatin powders, or other biopolymers can likewise be utilized to secure RFID chip 300 within a particular semen straw. Hydrogels are polymer networks having hydrophilic properties. Hydrogels are simply a hydrophilic polymeric network cross-link in some fashion to produce an elastic structure. Hydrogels can be prepared from either synthetic polymers or natural polymers. Hydrogels can achieve high degrees of swelling or expansion and can be used as a sealing agent. Hydrogels can be manufactured and produced to achieve any degree of swelling or expansion as desired. As a result hydrogels can be designed and tailored to meet the needs of a specific application. The favorable property of hydrogels is their ability to swell or expand when put in contact with aqueous solution. These hydrogels swell rapidly to a large size and can be used to encapsulate the RFID chip 300 within a particular semen or embryo straw.

Gelatin powders that are used to make a jelly like substance can likewise be utilized to hold and seal an RFID chip within a semen or embryo straw. Importantly, like hydrogels, a gelatin powder can be fabricated so that it absorbs water or an aqueous solution thereby causing a reaction or expansion when the liquid or extender associated with the sperm in the semen is allowed to penetrate the hydrogel or gelatin powder. As best illustrated in FIG. 10, a semen or embryo straw 1000 includes an elongated annular member 1005 having a first end 1010 and a second end 1015. The first end 1010 of straw member 1005 includes a hydrogel or gelatin powder 1025 wherein RFID chip 300 is position either fully or partially within the hydrogel or gelatin powder 1025 as illustrated in FIG. 10. The hydrogel or gelatin powder 1025 prevents the semen from reaching the powder while allowing only the liquid associated with the semen to pass into the hydrogel or gelatin powder for sealing. When the liquid or extender associated with the sperm and the semen is allowed to penetrate the hydrogel or gelatin powder 1025, a reaction in the hydrogel or gelatin powder occurs which allows the hydrogel or gelatin powder to swell or expand thereby sealing or encapsulating the RFID chip 300 within the hydrogel or gelatin powder. Since the hydrogel or gelatin powder absorbs the liquid or extender from the sperm in the semen, this absorption allows the swelling or expansion to take place thereby fixing the RFID chip 300 within the straw end portion of 1010. Once the straw 1000 is filled with a biological material, the liquid or extender associated with the semen would than penetrate the hydrogel or gelatin powder 1025 causing the sealing reaction as previously explained.

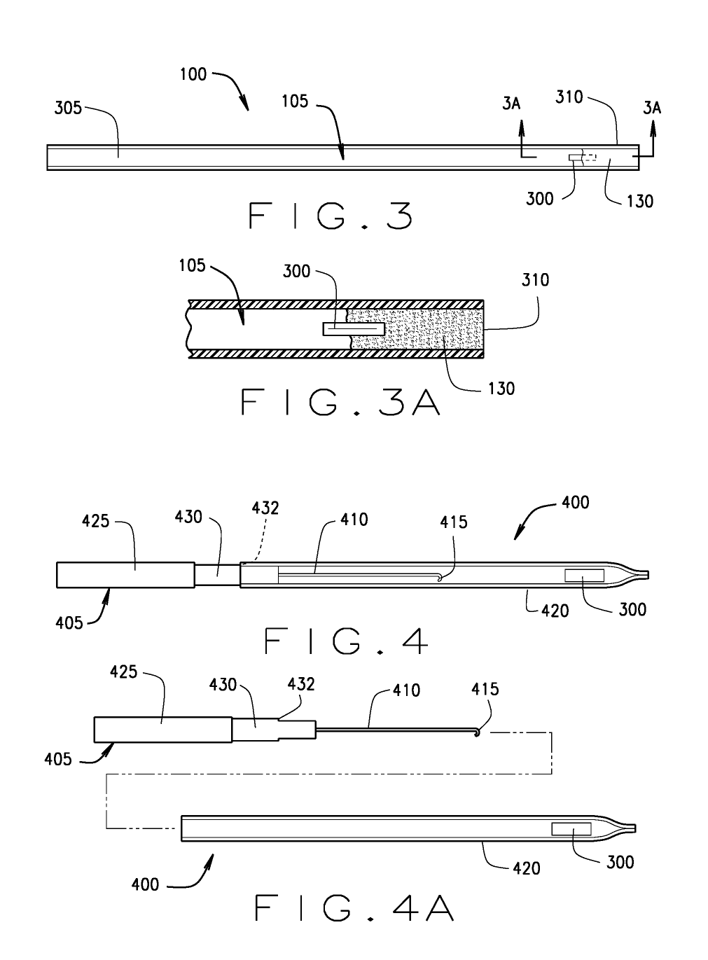

As illustrated in FIGS. 4 and 4A, another embodiment of the present container identification system includes incorporating an RFID chip into a vitrification straw 400. The vitrification straw 400 includes a handle 405, a first member 410, a hook 415, a cover 420, and an RFID chip 300 within the cover 420. The handle 405 preferably includes a first section 425 and a second section 430, the second section 430 having at least a portion thereof which has a smaller diameter than the remaining portion of the section 430 thereby forming a flange or ledge 432. The second section 430 of the handle 405 lies adjacent to first member 410 as best illustrated in FIG. 4A. First member 410 includes a hook 415, but hook 415 may be a loop, or even a thin flat piece of material such as a sheet of plastic or metal, or something similar. Hook 415 can be in any shape that would be able to hold a biological sample, such as a drop of liquid containing an oocyte, embryo or semen sample, without the sample separating from the hook, holder or sample placement material. The hook 415 may also be a cryoloop which is a loop that holds a drop of liquid with gametes in it. Regardless of the shape or type of hook 415, it must also allow for a fast freeze of the biological material.

In operation, semen, oocytes, embryos or other biological material are placed on hook 415 and cover 420 is placed over hook 415, first member 410, and second section 430 such that it abuts first section 425. Cover 420 prevents the sample on hook 415 from being bumped or brushed against causing it to fall off before cryopreservation, or prevents it from becoming contaminated with bacteria during cryopreservation, and is preferably removable so that the sample can be placed in the straw. In one embodiment, RFID chip 300 is held loose within the cover 420. In another embodiment, the RFID chip 300 may be placed within the cover and secured thereto via such methods as an adhesive, a sealant, or a crimp in the straw so the RFID chip 300 cannot fall out. Other methods of securing the RFID chip 300 within the cover 420 are envisioned and foreseeable.

In still another alternative embodiment of the present invention as illustrated in FIGS. 5 and 5A, the handle 405 of vitrification straw 400 may have a cover 500 that preferably surrounds the handle 405. The RFID chip 300 can also be incorporated into the vitrification straw by placing the RFID chip 300 between the cover 500 and the handle 405 as illustrated in FIGS. 5 and 5A.

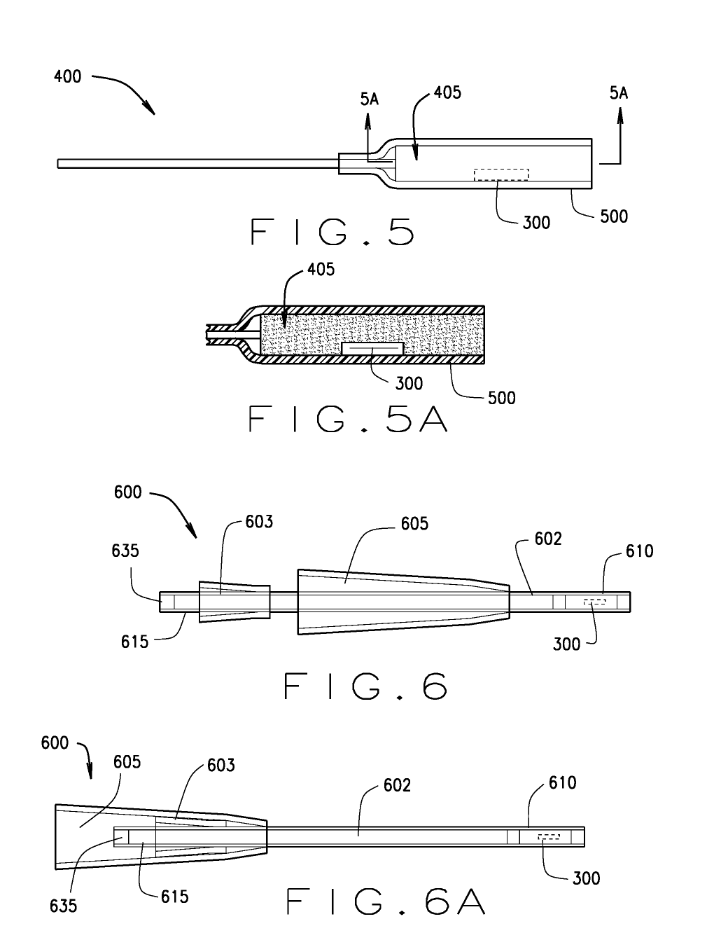

As shown in FIG. 6, the RFID chip 300 can also be placed in a vitrification straw 600 which includes an elongated straw member 602, a stopper 603, a cover 605, and a RFID chip 300. Straw member 602 is a hollow, elongated, annular member substantially similar to straw member 105 and includes a first open end 610 and a second end 615. The RFID chip 300 is preferably placed within hollow straw member 602 at the first open end 610. After the RFID chip 300 is inserted into the first end 610, it is sealed preferably by crimping or plugging that end with a conventional straw plug. In addition, the first end 610 of vitrification straw 600 can likewise be sealed by resin powder or a hydrogel as previously explained, or some other sealing method such as by using at least one sealing component such as a cotton plug associated with the resin powder wherein the RFID tag is at least partially inserted into the at least one sealing component. The second end 615 of straw 600 includes a tip 635 that is preferably thin, durable, and will not break when immersed in liquid nitrogen. As shown in FIG. 6A, cover 605 is movable over tip 635 which contains the biological samples, thereby preventing the sample from being brushed off or separated from tip 635. In this regard, the cover 605 could be positioned on the straw member 602 so as to be movable therealong to cover the tip 635, or the cover 605 can be positioned on the straw member 602 so as to slide along the straw member to a position where it covers the tip 635. Stopper 603 is associated with the straw member 602 and is positioned along the length of the straw member so as to prevent cover 605 from sliding too far over the tip 635 and off of the straw member 602.

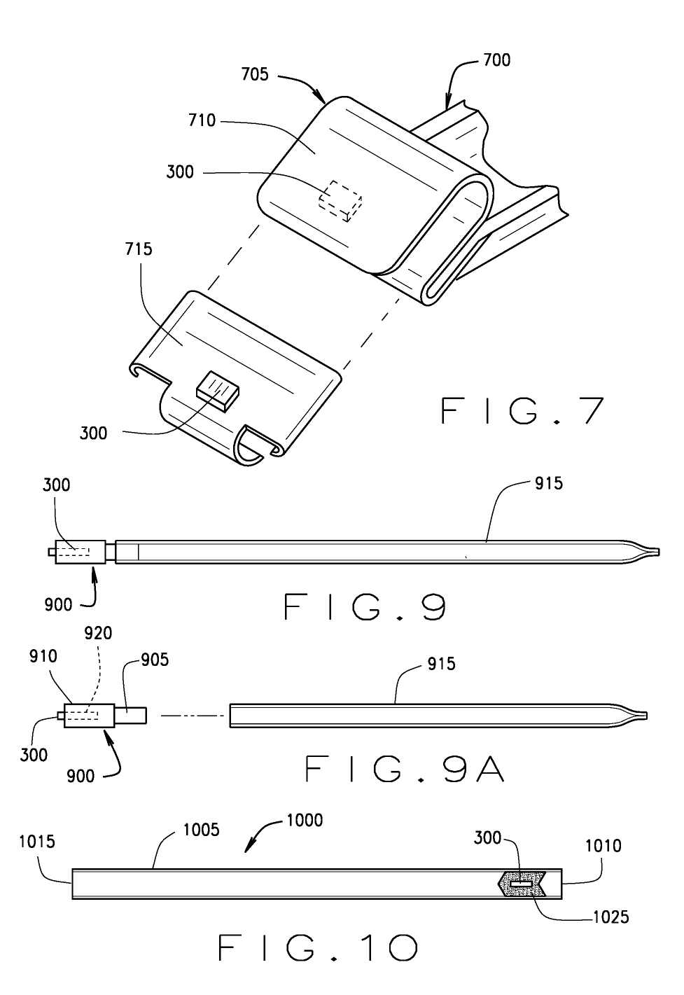

In addition to placing the RFID chip 300 into a straw, the RFID chip 300 can also be adhered to or integrated into the cane tab that is attached to a cane, or it can be attached directly to the cane itself as will be hereinafter further explained. As illustrated in FIG. 7, cane 700 is preferably a long open metal tube or basket capable of holding one or more straws or straw goblets for insertion into liquid nitrogen. Cane 700 has a first end 705 and a second end (not shown). When cane 700 is inserted into a Dewar Tank filled with liquid nitrogen, the first end 705 is proximal to the opening of the Dewar Tank as compared to the second end of cane 700. The first end 705 has a cane tab 710 which is a flat piece of metal as illustrated which may be used as a label. An RFID chip 300 may be integrated directly into or onto the cane tab 710. Alternatively, an RFID chip 300 may be integrated directly into a cane tab cover 715 by attaching the RFID chip 300 thereto using a permanent epoxy or other suitable attachment means. A cane tab cover 715 is preferably a thin piece of aluminum or other material that is removable, bends over, and locks onto the cane tab 710. Alternatively, an RFID chip 300 may be created in the shape of a cane tab cover 715 or as the cane tab 710 itself. FIG. 8 shows the cane 700, along with cane tab cover 715, inserted into the opening 800 of a Dewar Tank 805.

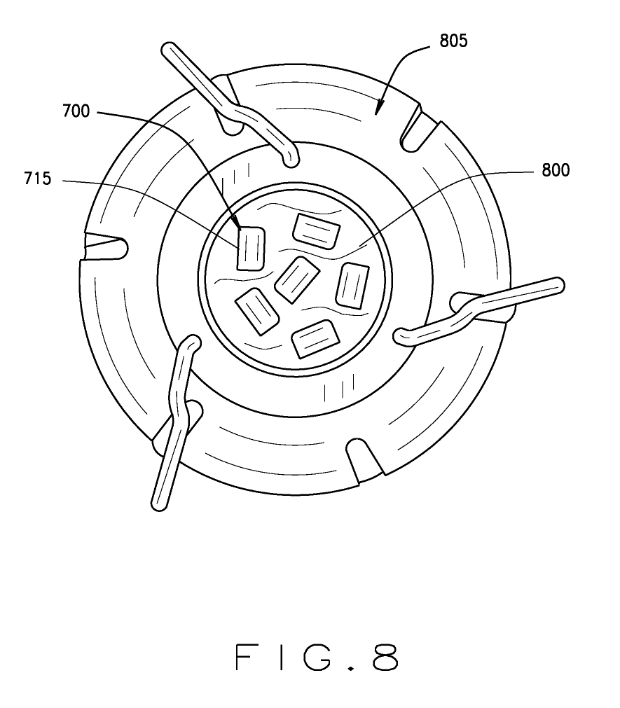

As illustrated in FIGS. 9 and 9A, a RFID chip 300 may also be attached to one end portion of a straw plug connector 900 which may be used to seal a straw. Plug 900 is preferably made out of plastic and includes first and second ends 905 and 910. The first end 905 of plug 900 preferably has a smaller diameter than second end 910. First end 905 preferably also has a smaller diameter than straw member 915 so that only the first end 905 of plug 900 may be frictionally inserted into straw member 915. Here again, straw member 915 is a long hollow tube, substantially similar to straw member 105. An RFID chip 300 is positioned and located on the second end 910 of plug 900. The RFID chip 300 could be glued, epoxied or otherwise attached to second end 910 so that the RFID chip remains on plug 900. Alternatively, the second end 910 of plug 900 could have an aperture 920 for receiving at least one end portion of RFID chip 300 into the second end 910. The RFID chip 300 can be secured within the aperture via an adhesive, epoxy or other suitable means of attachment. The RFID chip 300 may also be integrated into a mold of the straw plug 900.

As described above, an RFID chip may be integrated into any of the components of a semen straw, vitrification straw, or anything used for holding biological material during cryogenic storage, that is, a straw, a cane, a cane tab, a cane tab cover, and/or a plug or other closure member. The RFID chip may also be placed before or after the biological material is added to the straw or other receptacle and the straw or container may be sealed through several different methods. For example, one end of a straw may be sealed using a resin powder, a hydrogel or a gelatin powder, while the other end of the straw may be sealed using a plug, a crimp, heat or ultrasonic sealing or some other suitable closure method. Additionally, more than one RFID chip 300 may be associated with a semen straw or receptacle to ensure that there is still an RFID chip containing the information relating to the biological material in the straw or other receptacle if one of the RFID chips is damaged during cryopreservation. In this situation, an RFID chip can be associated with each opposite end of the straw or other container.

The present invention can also be used for storing somatic cells, for example, stem cells, for packaging and storing associated information.

The various constructions described above and illustrated in the drawings are presented by way of example only and are not intended to limit the concepts and principles of the present invention. Thus, there has been shown and described several embodiments of a novel gamete and embryo storage receptacle with RFID data identification. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present constructions and systems will, however, become apparent to those skilled in the art after considering the specification and the accompanying drawings. All such changes, modifications, variations and other uses and applications which do not depart from the spirit and scope of the invention are deemed to be covered by the invention.

What is claimed is:

1. A semen straw for holding semen therein and the sperm associated therewith including an elongated annular member having a first end and a second end, the first end of the elongated annular member having a first seal, the first seal including a sealing substance, the second end of the elongated annular member having a second seal, the improvement comprising a radio frequency identification (RFID) tag at least partially integrated into the sealing substance of the first seal.

2. The semen straw of claim 1 wherein the first seal further includes a first plug and a second plug, the sealing substance being located and positioned in-between the first plug and the second plug.

3. The semen straw of claim 1 wherein the RFID tag is fully encapsulated within the sealing sub stance.

4. The semen straw of claim 1 wherein at least one of said first and second plugs is made of a material which will allow a liquid or extender associated with the sperm in the semen to penetrate the one of the first and second plugs thereby causing a reaction with the sealing substance for allowing the sealing substance to harden or expand around the RFID tag when the straw is filled with semen.

5. The semen straw of claim 1 wherein the sealing substance is a resin powder.

6. The semen straw of claim 1 wherein the sealing substance is a hydrogel.

7. The semen straw of claim 4 wherein at least one of said first and second plugs is made of cotton.

8. The semen straw of claim 4 wherein at least one of said first and second plugs is made of a micron filter paper.

9. The semen straw of claim 1 wherein the second seal is a straw plug connector, the straw plug connector having a first end and a second end, the first end having a smaller diameter than the second end, the second end of the straw plug connector including a second RFID tag.

10. A semen straw for holding semen therein including an elongated annular member having a first end and a second end, the first end of the elongated annular member having a first seal, the first seal including a sealing substance, the second end of the elongated annular member having a second seal, the second seal including a straw plug connector, the improvement comprising a first radio frequency identification (RFID) tag at least partially integrated into the sealing substance of the first seal and a second radio frequency identification (RFID) tag located on the straw plug connector.

11. A semen straw for holding semen therein including an elongated annular member having a first end and a second end, the first end of the elongated annular member having a first seal, the second end of the elongated annular member having a second seal, the improvement comprising a radio frequency identification (RFID) tag located on the second seal.

12. The semen straw of claim 11 wherein the second seal includes a straw plug connector.

13. The semen straw of claim 12 wherein the straw plug connector has a first end and a second end, the first end of the straw plug connector being insertable into the second end of the elongated annular member and the second end of the straw plug connector including the RFID tag.

14. The semen straw of claim 13 wherein the second end of the straw plug connector includes an aperture, the RFID tag being at least partially insertable into said aperture.

15. A vitrification straw for holding a biological sample during vitrification including a handle, a member for holding the biological sample and a cover, the handle being positioned and located adjacent to the member, the cover being selectively engageable with the handle such that the cover extends over the member, the improvement comprising a radio frequency identification (RFID) tag positioned and located on the cover.

16. The vitrification straw of claim 15 wherein the RFID is permanently attached to the cover.

17. The vitrification straw of claim 15 wherein the RFID tag is positioned within the cover.

18. The vitrification straw of claim 15 wherein the handle includes a first section and a second section, the second section including a ledge for engaging one end portion of the cover when the cover is selectively engaged with the handle.

19. The vitrification straw of claim 18 wherein the member includes a hook for holding the biological sample, the cover being selectively engageable with the second section of the handle such that the cover extends over both the hook and the member.

20. The vitrification straw of claim 15 wherein the biological sample is one of an egg, primordial germ cell, embryo and oocyte.

21. A vitrification straw for holding a biological sample having a handle, a member for holding the biological sample, and a cover, the handle being adjacent to the member, the cover being selectively positionable over the handle, the improvement comprising a radio frequency identification (RFID) tag positioned and located in-between the cover and the handle when the cover is positioned over the handle.

22. A vitrification straw for holding a biological sample having an elongated annular member having a first open end and a second end, the first open end of the elongated annular member having a seal, the second end of the elongated annular having a tip for holding the biological sample, and a cover positionable on the elongated annular member and movable over the tip, the improvement comprising a radio frequency identification (RFID) tag positioned within the first open end of the elongated annular member such that the RFID tag is sealed within the elongated annular member by the seal.

23. The vitrification straw of claim 22 wherein the seal includes a straw plug connector.

24. The vitrification straw of claim 22 wherein the seal includes a sealing substance, the sealing substance being inserted into the first open end of the elongated annular member and the RFID tag being at least partially inserted into the sealing substance.

25. The vitrification straw of claim 24 wherein the sealing substance is a resin powder.

26. The vitrification straw of claim 24 wherein the sealing substance is a hydrogel.

27. The vitrification straw of claim 22 including a stopper member associated with the elongated annular member, the cover being movable so as to engage the stopper member.

28. The vitrification straw of claim 22 wherein the seal includes at least one sealing component and the RFID tag being at least partially inserted into the at least one sealing component.

29. A cane having an open tubular structure capable of holding one or more straws, the cane having a first end and a second end, the first end of the cane having a cane tab, the improvement comprising a radio frequency identification (RFID) tag located and positioned on the cane.

30. The cane of claim 29 wherein the RFID tag is located and positioned on the cane tab.

31. The cane of claim 30 wherein the RFID tag is integrally formed with the cane tab.

32. The cane of claim 29 including a cane tab cover for positioning over the cane tab, the RFID tag being located and positioned on the cane tag cover.

33. The cane of claim 32 wherein the RFID tag is integrally formed with the cane tab cover.

34. The cane of claim 30 wherein the cane tab is a flat piece of metal.

35. The cane of claim 32 wherein the cane tab cover is a thin piece of material selectively engageable with the cane tab.

36. A straw plug connector for sealing one end of a semen straw, the straw plug connector having a first end and a second end, the first end of the straw plug connector having a smaller diameter than the second end of the straw plug connector, the improvement comprising a radio frequency identification (RFID) tag associated with the second end.

37. The straw plug connector of claim 36 wherein the second end of the straw plug connector includes an aperture, the RFID tag being at least partially insertable into said aperture.

38. The straw plug connector of claim 36 wherein the RFID tag is integrally formed into a portion of said straw plug connector.
